(19) United States
(12) Patent Application Publication
(10) Pub. No.: US 2024/0375993 A1
(43) Pub. Date: Nov. 14, 2024

(54) GLASS COMPOSITIONS HAVING IMPROVED UV ABSORPTION AND METHODS OF MAKING THE SAME

(71) Applicant: CORNING INCORPORATED, CORNING, NY (US)

(72) Inventor: Peter Joseph Lezzi, Corning, NY (US)

(21) Appl. No.: 18/564,840

(22) PCT Filed: May 26, 2022
(86) PCT No.: PCT/US2022/031005

§ 371 Date: Nov. 28, 2023

Related U.S. Application Data
(60) Provisional application No. 63/195,376, filed on Jun. 1, 2021.

(51) Int. Cl. C03C 3/095; C03C 4/08

(52) U.S. Cl. CPC C03C 3/095; C03C 4/085; C03C 2204/00

(57) ABSTRACT

A glass composition includes: greater than or equal to 65.7 mol % and less than or equal to 68 mol % Si0₂; greater than or equal to 9 mol % and less than or equal to 12.6 mol % Al₂O₃; greater than or equal to 1.7 mol % and less than or equal to 11.2 mol % B₂O₃; greater than or equal to 0.09 mol % and less than or equal to 5.4 mol % MgO; greater than or equal to 0.02 mol % and less than or equal to 9.39 mol % CaO, and greater than or equal to 0.02 mol % and less than or equal to 1.6 mol % CeO₂.

### CROSS-REFERENCE TO RELATED APPLICATIONS

This application claims the benefit of priority under 35 U.S.C. § 119 of U.S. Provisional Application No. 63/195,376, filed Jun. 1, 2021, the content of which is incorporated herein by reference in its entirety.

### FIELD

The present specification generally relates to UV absorbing glass compositions and, in particular, to UV absorbing glass compositions having a coefficient of thermal expansion to enable improved performance and yield in processing (e.g. lamination).

### BACKGROUND

Modifying glass compositions to provide improvement in one attribute for a particular application often comes at the expense of other attributes, which may also be needed for the particular application. Previous UV absorbing glass compositions utilized large amounts of expensive materials to provide an improved UV absorption. Unfortunately, these compositions were expensive to make and had an additional drawback of a high coefficient of thermal expansion, which contributes to issues in lamination processes. Accordingly, a need exists for alternative glasses which have improved UV absorption while also having a low coefficient of thermal expansion.

### SUMMARY

The present disclosure is directed towards various embodiments of a new series of glass compositions which provide improved UV blocking characteristics and extended lifetime to components that they may be applied to, to reduce, prevent and/or eliminate degradation cased to the components after extended/prolonged UV exposure. Additionally, these embodiments can be made on currently fusion forming, rolling, slot draw, and/or float processes. Further, the embodiments have a lower coefficient of thermal expansion (CTE) as compared to previous UV absorbing glass compositions, where other attributes including density and/or CTE contributes to improved light weighting and/or improved lamination processing and performance for end use applications utilizing such glass compositions.

The embodied compositions described herein are directed towards utilizing one or more UV absorbing components, each having different UV absorbing sensitivity, to tailor glass compositions having tailored, unique properties of low coefficient of thermal expansion and high UV absorption at target/desired wavelengths. More specifically, low amounts of cerium, an expensive rare earth raw material, optionally in combination with at least one of titanium and/or iron is utilized in one or more embodiments of the present disclosure in the novel glass compositions described herein to achieve these results.

By evaluating many iterations of the example compositions embodied herein, it was surprisingly identified that, the effect of varying cerium content, at constant titanium content, was highly sensitive to the transmission at the UV waveband. Similarly, it was surprisingly identified that, the effect of varying titanium content at constant cerium content, had a low sensitivity to the transmission at the UV waveband. Utilizing this data, new compositions with improved UV absorption at the desired wavelength were identified.

In a first embodiment of the present disclosure, a glass composition is provided comprising: greater than or equal to 65.7 mol % and less than or equal to 68 mol % SiO₂; greater than or equal to 9 mol % and less than or equal to 12.6 mol % Al₂O₃; greater than or equal to 1.7 mol % and less than or equal to 11.2 mol % B₂O₃; greater than or equal to 0.09 mol % and less than or equal to 5.4 mol % MgO; greater than or equal to 0.02 mol % and less than or equal to 9.39 mol % CaO, and greater than or equal to 0.02 mol % and less than or equal to 1.6 mol % CeO2.

In a second embodiment, the glass composition of embodiment 1, further comprises: less than or equal to 3 mol % TiO₂, where at least some TiO₂ is present.

In a third embodiment, the glass composition of embodiment 1, further comprises: greater than or equal to 0.4 mol % and less than or equal to 2.5 mol % TiO₂.

In a fourth embodiment, the glass composition of embodiment 1 further comprises: greater than or equal to 1 mol % and less than or equal to 3 mol % TiO₂.

In a fifth embodiment, the glass composition of any of embodiments 1 to 4 further comprises less than or equal to 0.2 mol % Fe₂O₃, where at least some Fe₂O₃ is present.

In a sixth embodiment, the glass composition of any of embodiments 1 to 4 further comprise: greater than or equal to 0.01 mol % and less than or equal to 0.1 mol % Fe₂O₃.

In a seventh embodiment, the glass composition of any of embodiments 1 to 6 further comprise greater than or equal to 0.1 mol % and less than or equal to 0.8 mol % CeO₂.

In an eighth embodiment, the glass composition of any of embodiment 1 to embodiment 7, further comprises greater than or equal to 0.4 mol % and less than or equal to 2 mol % MgO.

In a ninth embodiment, the glass composition of any of embodiment 1 to embodiment 8, wherein the glass composition further comprises greater than or equal to 6 mol % and less than or equal to 9 mol % CaO.

In a tenth embodiment, the glass composition of any of embodiment 1 to embodiment 9, wherein the glass composition comprises greater than or equal to 5 mol % and less than or equal to 11.2 mol % B₂O₃.

In an eleventh embodiment, the glass composition of any of embodiment 1 to embodiment 10, wherein the glass composition comprises greater than or equal to 0.15 mol % and less than or equal to 0.5 mol % SrO.

In a twelfth embodiment, the glass composition of any of embodiment 1 to embodiment 11, wherein the glass composition comprises less than or equal to 15.3 mol % Na₂O, where at least some Na₂O is present.

In a thirteenth embodiment, the glass composition of any of embodiment 1 to embodiment 12, wherein the glass composition comprises less than or equal to 0.01 mol % K₂O, where at least some K₂O is present.

In a fourteenth embodiment, the glass composition of any of embodiment 1 to embodiment 13, wherein the glass composition comprises less than or equal to 0.15 mol % SnO₂, where at least some SnO₂ is present.

In a fifteenth embodiment, the glass composition of any of embodiment 1 to embodiment 14, wherein the glass composition comprises less than or equal to 0.1 mol % ZrO₂, where at least some ZrO₂ is present.

In a sixteenth embodiment, the glass composition of any of embodiment 1 to embodiment 15, wherein the glass composition has density of not greater than 2.4.

In a seventeenth embodiment, the glass composition of any of embodiment 1 to embodiment 16, wherein the glass composition has CTE when measured at 500 degrees C., of not greater than 3.4 ppm.

In an eighteenth embodiment, the glass composition of any of embodiment 1 to embodiment 17, wherein the glass composition, having a thickness of 250 microns, has a 50% transmission percentage at a UV wavelength in the range of 320 to 350 nm.

In a nineteenth embodiment, a glass composition comprising: greater than or equal to 66 mol % and less than or equal to 68 mol % SiO₂; greater than or equal to 9 mol % and less than or equal to 11 mol % Al₂O₃; greater than or equal to 10 mol % and less than or equal to 11.2 mol % B₂O₃; greater than or equal to 0.4 mol % and less than or equal to 2 mol % MgO; greater than or equal to 6 mol % and less than or equal to 9.4 mol % CaO; greater than or equal to 0.15 mol % and less than or equal to 0.5 mol % SrO; greater than or equal to 0.4 mol % and less than or equal to 2 mol % TiO₂; greater than or equal to 0.1 mol % and less than or equal to 1 mol % CeO₂; greater than or equal to 0.01 mol % and less than or equal to 0.05 mol % Fe₂O₃; and not greater than or equal to 0.01 mol %, where at least some ZrO₂ is present.

In a twentieth embodiment, the embodiment of 19 further comprises not greater than or equal to 0.06 mol % SnO₂, where at least some SnO₂ is present.

In a twenty-first embodiment, a glass composition comprising: greater than or equal to 66 mol % and less than or equal to 68 mol % SiO₂; greater than or equal to 9 mol % and less than or equal to 11 mol % Al₂O₃; greater than or equal to 10 mol % and less than or equal to 11.2 mol % B₂O₃; greater than or equal to 0.4 mol % and less than or equal to 2 mol % MgO; greater than or equal to 6 mol % and less than or equal to 9.4 mol % CaO; greater than or equal to 0.4 mol % and less than or equal to 2 mol % TiO₂; greater than or equal to 0.4 mol % and less than or equal to 0.8 mol % CeO₂; greater than or equal to 0.05 mol % and less than or equal to 0.1 mol % Fe₂O₃; and greater than or equal to 0.01 mol % and less than or equal to 0.1 mol % ZrO₂.

In a twenty second embodiment, the glass composition of embodiment 21 further comprises: not greater than or equal to 0.26 mol % SrO, where at least some SrO is present.

In a twenty third embodiment, a glass composition comprises: greater than or equal to 66 mol % and less than or equal to 68 mol % SiO₂; greater than or equal to 9 mol % and less than or equal to 11 mol % Al₂O₃; greater than or equal to 10 mol % and less than or equal to 11.2 mol % B₂O₃; greater than or equal to 0.4 mol % and less than or equal to 0.8 mol % MgO; greater than or equal to 7 mol % and less than or equal to 9.4 mol % CaO; greater than or equal to 0.4 mol % and less than or equal to 0.7 mol % SrO; not greater than or equal to 0.01 mol % K₂O, where at least some K₂O is present; greater than or equal to 0.5 mol % and less than or equal to 2.5 mol % TiO₂; greater than or equal to 0.4 mol % and less than or equal to 1.5 mol % CeO₂; greater than or equal to 0.05 mol % and less than or equal to 0.2 mol % Fe₂O₃; and not greater than or equal to 0.01 mol %, where at least some ZrO₂ is present.

In a twenty fourth embodiment, a glass composition is provided, comprising: greater than or equal to 66 mol % and less than or equal to 68 mol % SiO₂; greater than or equal to 9 mol % and less than or equal to 11 mol % Al₂O₃; greater than or equal to 10 mol % and less than or equal to 11.2 mol % B₂O₃; greater than or equal to 0.09 mol % and less than or equal to 2 mol % MgO; greater than or equal to 7 mol % and less than or equal to 9.4 mol % CaO; greater than or equal to 0.4 mol % and less than or equal to 0.7 mol % SrO; greater than or equal to 0.8 mol % and less than or equal to 2.5 mol % TiO₂; greater than or equal to 0.4 mol % and less than or equal to 1 mol % CeO₂; not greater than 0.09 mol % Fe₂O₃, wherein at least some Fe₂O₃ is present; and greater than or equal to 0.01 mol % ZrO₂, where at least some ZrO₂ is present.

In a twenty-fifth embodiment, a glass composition is provided, comprising: greater than or equal to 66 mol % and less than or equal to 68 mol % SiO₂; greater than or equal to 9 mol % and less than or equal to 11 mol % Al₂O₃; greater than or equal to 7 mol % and less than or equal to 11.2 mol % B₂O₃; greater than or equal to 1.5 mol % and less than or equal to 2.5 mol % MgO; greater than or equal to 7 mol % and less than or equal to 9.4 mol % CaO; greater than or equal to 0.4 mol % and less than or equal to 0.7 mol % SrO; greater than or equal to 0.4 mol % and less than or equal to 1.6 mol % CeO₂; greater than or equal to 0.07 mol % and less than or equal to 0.1 mol % SnO₂; and greater than or equal to 0.01 mol % ZrO₂, where at least some ZrO₂ is present.

In a twenty sixth embodiment, the glass composition of embodiment 25, further comprising: greater than or equal to 0.8 mol % and less than or equal to 2.5 mol % TiO₂.

In a twenty seventh embodiment, the glass composition of either of embodiment 25 or embodiment 26, further comprising: not greater than 0.01 mol % Fe₂O₃, wherein at least some Fe₂O₃ is present.

In a twenty-eight embodiment, a glass composition is provided, comprising: greater than or equal to 66 mol % and less than or equal to 68 mol % SiO₂; greater than or equal to 11 mol % and less than or equal to 13 mol % Al₂O₃; greater than or equal to 1.7 mol % and less than or equal to 4 mol % B₂O₃; greater than or equal to 1.5 mol % and less than or equal to 2.5 mol % MgO; greater than or equal to 11 mol % and less than or equal to 14 mol % Na₂O; greater than or equal to 0.4 mol % and less than or equal to 1.6 mol % CeO₂; and greater than or equal to 0.07 mol % and less than or equal to 0.15 mol % SnO₂.

In a twenty ninth embodiment, a glass composition of embodiment 28 further includes: greater than or equal to 0.8 mol % and less than or equal to 2.5 mol % TiO₂.

In a thirtieth embodiment, a glass composition is provided, comprising: greater than or equal to 66 mol % and less than or equal to 68 mol % SiO₂; greater than or equal to 11 mol % and less than or equal to 13 mol % Al₂O₃; greater than or equal to 4 mol % and less than or equal to 6.5 mol % MgO; greater than or equal to 11 mol % and less than or equal to 15.3 mol % Na₂O; greater than or equal to 0.8 mol % and less than or equal to 3 mol % TiO₂. greater than or equal to 0.2 mol % and less than or equal to 0.6 mol % CeO₂; and greater than or equal to 0.07 mol % and less than or equal to 0.15 mol % SnO₂.

Additional features and advantages of the glass compositions described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 provides transmission curves of Example 7 compositions at substrates having three different thicknesses, depicting an example of the effect that thickness and UV absorbing components, including cerium content and titanium content, have on the resulting UV transmission of some embodiments of the present disclosure.

FIG. 2 provides a series of modeled percent transmission at 350 nm for varying UV absorbing component amounts, as specified in the accompanying table. The data points on the graph depict measured values, while the trend lines (dotted lines and/or accompanying equations) provide extrapolated percent transmission for varying compounds, in accordance with one or more aspects of the present disclosure.

FIG. 3 depicts a graph of transmission curves for four different compositions, two of embodiments of the present invention (Example 15 and Example 18), and for reference purposes, two comparative compositions with UV absorbing capabilities, but at a very different composition (0213 and 0214, commercially available through Corning Incorporated), in accordance with one or more embodiments of the present disclosure.

FIG. 4 depicts a series of transmission curves plotted for embodiment compositions of the present disclosure, Example 24, Example 26, and Example 29 (also coinciding with left-most transmission curve to right-most transmission curve as depicted in FIG. 4), in accordance with one or more aspects of the present disclosure.

FIG. 5 depicts transmission curves for three embodiments of the present disclosure (Example 13, Example 17, and Example 21) as compared to three comparative examples, including Willow® glass, 0213, and 0214, each of which is commercially available from Corning Incorporated, in accordance with one or more embodiments of the present disclosure.

FIG. 6 depicts seven percent total transmission curves, plotted as % total transmission by wavelength in nm, for embodiment of Example 41 at four different sample thicknesses, depicting transmission changing with thickness for the same embodiment composition, in accordance with one or more aspects of the present disclosure. As thickness increases (from 0.03 to 0.05 to 0.10 to 0.25 mm thick to 0.50 mm thick to 0.70 mm thick to 1.00 mm thick), the wavelength of 50% transmission shifts upward (from approximately 320nm to 330nm to 340nm to 360nm to 375nm to 380 nm to 395nm).

### DETAILED DESCRIPTION

Reference will now be made in detail to various embodiments of UV blocking glass compositions having improved properties, including low coefficient of thermal expansion. Various embodiments of UV absorbing glass compositions and methods of making such glasses will be described herein with specific reference to the appended drawings.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom-are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

In the embodiments of the glass compositions described herein, the concentrations of constituent components (e.g., SiO₂, Al₂O₃, and the like) are specified in mole percent (mol %) on an oxide basis, unless otherwise specified.

The terms “0 mol %” and “substantially free,” when used to describe the concentration and/or absence of a particular constituent component in a glass composition, means that the constituent component is not intentionally added to the glass composition. However, the glass composition may contain traces of the constituent component as a contaminant or tramp in amounts of less than 0.01 mol %.

Transmission data (i.e., total transmission), as described herein, is measured with a Lambda 950 UV/Vis Spectrophotometer manufactured by PerkinElmer Inc. (Waltham, Massachusetts USA). Total transmission is measured on a flat polished glass article to minimize the amount of reflectivity without the use of any coating treatment.

The term “average transmission,” as used herein, refers to the average of transmission made within a given wavelength range with each wavelength weighted equally. In the embodiments described herein, the “average transmission” is reported over the wavelength range from 400 nm to 800 nm (inclusive of endpoints).

The viscosity of the glass composition, as described herein, is measured according to ASTM C965-96.

The term “Vogel-Fulcher-Tamman (‘VFT’) relation,” as used herein, described the temperature dependence of the viscosity and is represented by the following equation:

$$log η = A + \frac{B}{T - {T}_{o}}$$

where η is viscosity. To determine VFT A, VFT B, and VFT Tₒ, the viscosity of the glass composition is measured over a given temperature range. The raw data of viscosity versus temperature is then fit with the VFT equation by least-squares fitting to obtain A, B, and Tₒ. With these values, a viscosity point (e.g., 200 P Temperature, 35000 P Temperature, and 200000 P Temperature) at any temperature above softening point may be calculated.

The term “melting point,” as used herein, refers to the temperature at which the viscosity of the glass composition is 200 poise as measured in accordance with ASTM C338.

The term “softening point,” as used herein, refers to the temperature at which the viscosity of the glass composition is 1×10^{7.6} poise. The softening point is measured according to the parallel plate viscosity method which measures the viscosity of inorganic glass from 107 to 109 poise as a function of temperature, similar to ASTM C1351M.

The terms “annealing point” or “effective annealing temperature” as used herein, refer to the temperature at which the viscosity of the glass composition is 1×10^{13.18} poise. In embodiments, maintaining the glass composition at the effective annealing temperature of the glass composition ±20° C. for a time greater than or equal to 15 minutes and less than or equal to 1 hour may relieve internal stresses present in accordance with ASTM C598.

The term “strain point,” as used herein, refers to the temperature at which the viscosity of the glass composition is 1×10^{14.68} poise as measured in accordance with ASTM C598.

Density, as described herein, is measured by the buoyancy method of ASTM C693-93.

The term “CTE,” as used herein, refers to the instantaneous coefficient of thermal expansion of the glass composition at 300° C. cooling (i.e., the instantaneous CTE at 300° C., measured while cooling) or at 50° C. cooling (i.e., the instantaneous CTE at 50° C., measured while cooling), as specified.

The term “liquidus viscosity,” as used herein, refers to the viscosity of the glass composition at the onset of devitrification (i.e., at the liquidus temperature as determined with the gradient furnace method according to ASTM C829-81).

The term “liquidus temperature,” as used herein, refers to the temperature at which the glass composition begins to devitrify as determined with the gradient furnace method according to ASTM C829-81.

The elastic modulus (also referred to as Young's modulus) of the glass composition, as described herein, is provided in units of gigapascals (GPa) and is measured in accordance with ASTM C623.

Shear modulus of the glass composition, as described herein, is provided in units of gigapascals (GPa). The shear modulus of the glass composition is measured in accordance with ASTM C623.

Poisson's ratio, as described herein is measured in accordance with ASTM C623.

Refractive index, as described herein, is measured in accordance with ASTM E1967.

The phrases “average heating rate” and “average cooling rate,” as used herein, are measured using the total change in temperature recorded by a thermocouple divided by the total time of heating or cooling, respectively.

Disclosed herein are glass compositions which mitigate the aforementioned problems. Specifically, the glass compositions having at least one UV absorbing component (e.g. at least one of Ce, with optionally Ti and/or Fe, with UV absorbing agents in oxide form), which results in improved UV absorbing glass compositions having a CTE amenable to ease in downstream processing, including lamination, to an article having a UV absorbing glass substrate.

The glass compositions described herein may be described as aluminoborosilicate glass compositions and comprise SiO₂, Al₂O₃, B₂O₃, and a UV absorbing component, such as CeO₂, TiO₂, and/or Fe₂O₃, In addition to SiO₂, Al₂O₃, B₂O₃, and at least one UV absorbing component, the glass compositions embodied and described herein also include alkali oxides, such as Na₂O, to enable the ion-exchangeability of the glass compositions.

In all embodiments of the present disclosure, at least some cerium (CeO₂) is present as a UV absorbing agent. In some embodiments, Ce is used individually. In some embodiments, Ce is used in combination with at least one of Ti and Fe. When Ce is used in conjunction with Ti, it was determined that a lower Ce content could be utilized to achieve desirable UV absorption at a target UV wavelength or wavelength range (while maintaining desirable properties including CTE for enhanced laminating/processing and density for light weighting).

In embodiments, the glass composition may comprise greater than or equal to 0.2 mol % and less than or equal to 1.6 mol % CeO₂. In embodiments, the glass composition may comprise greater than or equal to 0.4 mol. % and less than or equal to 1.2 mol % CeO₂. In embodiments, the concentration of CeO₂ in the glass composition may be greater than or equal to 0.2 mol %, greater than or equal to 0.4 mol %, or greater than or equal to 0.6 mol %: greater than or equal to 0.8 mol %, greater than or equal to 1 mol %, greater than or equal to 1.2 mol %, greater than or equal to 1.4 mol %, or even greater than or equal to 1.5 mol %.

In embodiments, the concentration of CeO₂ in the glass composition may be less than or equal to 1.6 mol %, less than or equal to 1.4 mol %, less than or equal to 1.2 mol %; less than or equal to 1 mol %, less than or equal to 0.8 mol %, less than or equal to 0.6 mol %, or even less than or equal to 0.4 mol %.

In embodiments, the glass composition may comprise greater than or equal to 0 mol % and less than or equal to 3 mol % TiO₂. In embodiments, the glass composition may comprise greater than or equal to 0.5 mol. % and less than or equal to 2.5 mol % TiO₂. In embodiments, the concentration of TiO₂ in the glass composition may be greater than or equal to 0.2 mol %, greater than or equal to 0.5 mol %, or greater than or equal to 1 mol %; greater than or equal to 1.5 mol %, greater than or equal to 2 mol %, or even greater than or equal to 2.5 mol %.

In embodiments, the concentration of TiO₂ in the glass composition may be less than or equal to 3 mol %, less than or equal to 2.5 mol %, less than or equal to 2 mol %; less than or equal to 1.5 mol %, less than or equal to 1 mol %, less than or equal to 0.5 mol %, or even less than or equal to 0.2 mol %.

In embodiments, the glass composition may comprise greater than or equal to 0 mol % and less than or equal to 0.2 mol % Fe₂O₃. In embodiments, the glass composition may comprise greater than or equal to 0.01 mol. % and less than or equal to 0.15 mol % Fe₂O₃. In embodiments, the concentration of Fe₂O₃ in the glass composition may be greater than or equal to 0.02 mol %, greater than or equal to 0.05 mol %, or greater than or equal to 0.1 mol %; greater than or equal to 0.15 mol %, or even greater than or equal to 0.18 mol %.

In embodiments, the concentration of Fe₂O₃ in the glass composition may be less than or equal to 0.2 mol %, less than or equal to 0.18 mol %, less than or equal to 0.15 mol %: less than or equal to 0.1 mol %, less than or equal to 0.08 mol %, less than or equal to 0.05 mol %, or even less than or equal to 0.02 mol %.

SiO₂ is the primary glass former in the glass compositions described herein and may function to stabilize the network structure of the glass compositions. The concentration of SiO₂ in the glass compositions should be sufficiently high (e.g., greater than or equal to 65 mol %) to provide basic glass forming capability. The amount of SiO₂ may be limited (e.g., to less than or equal to 68 mol %) to control the melting point of the glass composition, as the melting temperature of pure SiO₂ or high-SiO₂ glasses is undesirably high. Thus, limiting the concentration of SiO₂ may aid in improving the meltability and the formability of the glass composition.

Accordingly, in embodiments, the glass composition may comprise greater than or equal to 65.7 mol % and less than or equal to 68 mol % SiO₂, or any and all sub-ranges formed from any of these endpoints.

In embodiments, the glass composition may comprise greater than or equal to 66 mol % and less than or equal to 67.5 mol % SiO₂. In embodiments, the glass composition may comprise greater than or equal to 65.7 mol. % and less than or equal to 67 mol % SiO₂. In embodiments, the concentration of SiO₂ in the glass composition may be greater than or equal to 65.7 mol %, greater than or equal to 66 mol %, or even greater than or equal to 67 mol %.

In embodiments, the concentration of SiO₂ in the glass composition may be less than or equal to 68 mol %, less than or equal to 67 mol %, or even less than or equal to 66 mol %. or any and all sub-ranges formed from any of these endpoints.

Like SiO₂, Al₂O₃ may also stabilize the glass network and additionally provides improved mechanical properties and chemical durability to the glass composition. The amount of Al₂O₃ may also be tailored to the control the viscosity and/or phase separation of the glass composition. The concentration of Al₂O₃ should be sufficiently high (e.g., greater than or equal to 9 mol %) to enable the development of multiple phases through phase separation. However, if the amount of Al₂O₃ is too high, the viscosity of the melt may increase diminishing the formability of the glass composition. In embodiments, the glass composition may comprise greater than or equal to 9 mol % and less than or equal to 13 mol % Al₂O₃. In embodiments, the glass composition may comprise greater than or equal to 10 mol % and less than or equal to 12 mol % Al₂O₃. In embodiments, the glass composition may comprise greater than or equal to 10.5 mol % and less than or equal to 11.5 mol % Al₂O₃.

In embodiments, the concentration of Al₂O₃ in the glass composition may be greater than or equal to 9 mol %, greater than or equal to 10 mol %, or even greater than or equal to 11 mol %. In embodiments, the concentration of Al₂O₃ in the glass composition may be less than or equal 13 mol %, less than or equal to 12 mol %, less than or equal to 11 mol %, or even less than or equal to 11.5 mol %. In embodiments, the concentration of Al₂O₃ in the glass composition may be greater than or equal 9 mol % and less than or equal to 13 mol %, greater than or equal to 10 mol % and less than or equal to 12 mol %, greater than or equal to 11 mol % and less than or equal to 13 mol %, or greater than or equal 9 mol % and less than or equal to 12 mol %., or any and all sub-ranges formed from any of these endpoints.

B₂O₃ decreases the melting temperature of the glass composition. Furthermore, the addition of B₂O₃ in the glass composition helps achieve an interlocking crystal microstructure when the glass compositions are cerammed. In addition, B₂O₃ may also improve the damage resistance of the glass composition. When boron in the residual glass present after ceramming is not charge balanced by alkali oxides or divalent cation oxides (such as MgO, CaO, SrO, BaO, and ZnO), the boron will be in a trigonal-coordination state (or three-coordinated boron), which opens up the structure of the glass. The network around these three-coordinated boron atoms is not as rigid as tetrahedrally coordinated (or four-coordinated) boron. Without being bound by theory, it is believed that glass compositions that include three-coordinated boron can tolerate some degree of deformation before crack formation compared to four-coordinated boron. By tolerating some deformation, the Vickers indentation crack initiation threshold values increase. Fracture toughness of the glass compositions that include three-coordinated boron may also increase. The concentration of B₂O₃ should be sufficiently high (e.g., greater than or equal to 1.7 mol %) to enable the development of multiple phases through phase separation. However, if B₂O₃ is too high, the chemical durability and liquidus viscosity may suffer and the evaporation during melting becomes difficult to control. Therefore, the amount of B₂O₃ may be limited (e.g., less than or equal to 11.2 mol %) to maintain chemical durability and manufacturability of the glass composition.

In embodiments, the glass composition may comprise greater than or equal to 1.7 mol % and less than or equal to 11.2 mol % B₂O₃. In embodiments, the glass composition may comprise greater than or equal to 1.71 mol % and less than or equal to 11 mol % B₂O₃. or any and all sub-ranges formed from any of these endpoints.

In embodiments, the glass composition may comprise greater than or equal to 5 mol % and less than or equal to 10 mol % B₂O₃. or any and all sub-ranges formed from any of these endpoints.

In embodiments, the concentration of B₂O₃ in the glass composition may be greater than or equal to 1.7 mol. %; greater than or equal to 2 mol. %; greater than or equal to 2.5 mol. %; greater than or equal to 3 mol. %; greater than or equal to 3.5 mol. %; greater than or equal to 5 mol. %; greater than or equal to 5 mol. %; greater than or equal to 5.5 mol. %; greater than or equal to 6 mol. %; greater than or equal to 6.5 mol. %; greater than or equal to 7 mol. %; greater than or equal to 7.5 mol. %; greater than or equal to 8 mol. %; greater than or equal to 8.5 mol. %; greater than or equal to 9 mol. %; greater than or equal to 9.5 mol. %; greater than or equal to 10 mol. %; greater than or equal to 10.5 mol.

In embodiments, the concentration of B₂O₃ in the glass composition may be less than or equal to 12 mol %, less than or equal to 11.5 mol %, less than or equal to 11 mol %, less than or equal to 10.5 mol %, less than or equal to 10 mol %, less than or equal to 9.5 mol %, less than or equal to 9 mol %, less than or equal to 8.5 mol %, less than or equal to 8 mol %, less than or equal to 7.5 mol %, less than or equal to 7 mol %, less than or equal to 6.5 mol %, less than or equal to 6 mol %: less than or equal to 5.5 mol %, less than or equal to 5 mol %, less than or equal to 4.5 mol %, less than or equal to 4 mol %, less than or equal to 3.5 mol %, less than or equal to 3 mol %, less than or equal to 2.5 mol %, or even less than or equal to 2 mol %.

The glass compositions described herein include a relatively high concentration of Al₂O₃ and a relatively high concentration of B₂O₃. The total amount of Al₂O₃ and B₂O₃ in the glass composition may be limited (e.g., less than or equal to 25 mol %) to control the liquidus temperature of the glass composition, as an increased total amount of Al₂O₃ and B₂O₃ may increase the liquidus temperature. An increased liquidus temperature decreases the liquidus viscosity and stability of the glass composition so that the glass composition may no longer be suitable for downdrawing or fusion forming processes.

In embodiments, the total amount of Al₂O₃ and B₂O₃ in the glass composition (i.e., Al₂O₃+B₂O₃) may be greater than or equal to 10.5 mol % and less than or equal to 25 mol %.

As described hereinabove, the glass compositions may contain alkali oxides, such as Na₂O, to enable the ion-exchangeability of the glass compositions. In addition to aiding in ion exchangeability of the glass composition, Na₂O decreases the melting point and improves formability of the glass composition. However, if too much Na₂O is added to the glass composition, the melting point may be too low. In embodiments, the glass composition may comprise greater than or equal to 0 mol % and less than or equal to 15.3 mol % Na₂O. In embodiments, the concentration of Na₂O in the glass composition may be greater than or equal to 0 mol %, greater than or equal to 0.5 mol %, greater than or equal to 1 mol %, or even greater than or equal to 1.5 mol %. In embodiments, the concentration of Na₂O in the glass composition may be less than or equal to 15 mol %, less than or equal to 7.5 mol %, less than or equal to 5 mol %, less than or equal to 3.5 mol %, or even less than or equal to 3 mol %. In embodiments, the concentration of Na2O in the glass composition may be greater than or equal to 0 mol % and less than or equal to 15.3 mol %, greater than or equal to 0.5 mol % and less than or equal to 12 mol %, greater than or equal to 1 mol % and less than or equal to 9 mol %, greater than or equal to 1.5 mol % and less than or equal to 7 mol %, or any and all sub-ranges formed from any of these endpoints.

The glass compositions described herein may further comprise alkali metal oxides other than Na₂O, such as K₂O. K₂O promotes ion exchange to increase the depth of compression and decreases the melting point to improve formability of the glass composition. However, adding K₂O may cause the surface compressive stress and melting point to be too low. In embodiments, the concentration of K₂O in the glass composition may be greater than greater than or equal to 0 mol. % to not greater than or equal to 0.01 mol. %. In some embodiments, at least some K₂O is present, to not greater than 0.01 mol. %, or any and all sub-ranges formed from any of these endpoints.

The glass compositions described herein may further comprise MgO. MgO lowers the viscosity of the glass compositions, which enhances the formability, the strain point, and the Young's modulus, and may improve the ion exchangeability. However, when too much MgO is added to the glass composition, there is a significant decrease in the diffusivity of sodium and potassium ions in the glass composition which, in turn, adversely impacts the ion exchange performance (i.e., the ability to ion-exchange) of the resultant glass.

In embodiments, the concentration of MgO in the glass composition may be greater than or equal to 0.09 mol %, greater than or equal to 1.5 mol %, greater than or equal to 3 mol %, or even greater than or equal to 4.5 mol %. In embodiments, the concentration of MgO in the glass composition may be less than or equal to 5.4 mol %, less than or equal to 3 mol %, less than or equal to 1, or even less than or equal to 0.5 mol %.

In some embodiments, the concentration of MgO in the glass composition is greater than or equal to 0.09 mol % to and not greater than 5.4 mol. %, including any and all sub-ranges formed from any of these endpoints. In some embodiments, the concentration of MgO in the glass composition is greater than or equal to 0.5 mol % to and not greater than 3.5 mol. %, including any and all sub-ranges formed from any of these endpoints. In some embodiments, the concentration of MgO in the glass composition is greater than or equal to 1.5 mol % to and not greater than 3.5 mol. %, including any and all sub-ranges formed from any of these endpoints. In some embodiments, the concentration of MgO in the glass composition is greater than or equal to 2 mol % to and not greater than 4.5 mol. %, including any and all sub-ranges formed from any of these endpoints.

The glass compositions described herein may further comprise CaO. CaO lowers the viscosity of a glass composition, which enhances the formability, the strain point and the Young's modulus, and may improve the ion exchangeability. However, when too much CaO is added to the glass composition, the diffusivity of sodium and potassium ions in the glass composition decreases which, in turn, adversely impacts the ion exchange performance (i.e., the ability to ion-exchange) of the resultant glass.

In embodiments, the glass composition may comprise greater than or equal to 0.02 mol % and less than or equal to 9.4 mol % CaO, including any and all sub-ranges formed from any of these endpoints. In embodiments, the glass composition may comprise greater than or equal to 0.1 mol % and less than or equal to 7.5 mol % CaO, including any and all sub-ranges formed from any of these endpoints. In embodiments, the glass composition may comprise greater than or equal to 0.9 mol % and less than or equal to 5 mol % CaO, including any and all sub-ranges formed from any of these endpoints.

In embodiments, the concentration of CaO in the glass composition may be greater than or equal to 0.02 mol %, greater than or equal to 2.5 mol %, greater than or equal to 6.5 mol %, or even greater than or equal to 8 mol %. In embodiments, the concentration of CaO in the glass composition may be less than or equal to 9 mol %, less than or equal to 7.5 mol %, less than or equal to 5 mol %, less than or equal to 3.5 mol %, less than or equal to 1 mol %, or even less than or equal to 0.15 mol %.

In embodiments, the glass composition may comprise greater than or equal to 0 mol % and less than or equal to 0.53 mol % SrO, including any and all sub-ranges formed from any of these endpoints. In embodiments, the glass composition may comprise at least some SrO and less than or equal to 0.53 mol % SrO, including any and all sub-ranges formed from any of these endpoints. In embodiments, the glass composition may comprise at least some SrO and less than or equal to 0.25 mol % SrO, including any and all sub-ranges formed from any of these endpoints. In embodiments, the glass composition may comprise at least some SrO and less than or equal to 0.1 mol % SrO, including any and all sub-ranges formed from any of these endpoints.

In embodiments, the concentration of SrO in the glass composition may be greater than or equal to 0 mol %, greater than or equal to 0.1 mol %, greater than or equal to 0.3 mol %, or even greater than or equal to 0.45 mol %. In embodiments, the concentration of SrO in the glass composition may be less than or equal to 0.53 mol % or even less than or equal to 0.3 mol %. In embodiments, the glass composition may be substantially free of SrO.

In embodiments, the glass compositions described herein may further include one or more fining agents. In embodiments, the fining agents may include, for example, SnO₂. In embodiments, the concentration of SnO₂ in the glass composition may be greater than or equal to 0 mol %. In embodiments, the concentration of SnO₂ in the glass composition may be less than or equal to 0.15 mol %, less than or equal to 0.1 mol %, less than or equal to 0.05 mol %, or even less than or equal to 0.01 mol %. In embodiments, the concentration of SnO₂ in the glass composition may be greater than or equal to 0 mol % and less than or equal to 0.15 mol %, greater than or equal to 0 mol % and less than or equal to 0.05 mol %, greater than or equal to 0 mol % and less than or equal to 0.01 mol %, or any and all sub-ranges formed from any of these endpoints. In embodiments, the glass composition may be substantially free of SnO₂.

The glass composition may further include ZrO. In some embodiments, ZrO is present in an amount not exceeding 0.01 Mol. %, wherein at least some ZrO is present. In some embodiments, ZrO is optional (not included in the composition).

In embodiments, the glass compositions described herein may further include tramp materials such as FeO, MnO, MoO₃, La₂O₃, CdO, As₂O₃, Sb₂O₃, sulfur-based compounds, such as sulfates, halogens, or combinations thereof.

In embodiments, the glass composition may comprise: greater than or equal to 65.7 mol % and less than or equal to 68 mol % SiO₂; greater than or equal to 9 mol % and less than or equal to 12.6 mol % Al₂O₃; greater than or equal to 1.7 mol % and less than or equal to 11.2 mol % B₂O₃; greater than or equal to 0.09 mol % and less than or equal to 5.4 mol % MgO: greater than or equal to 0.02 mol % and less than or equal to 9.39 mol % CaO, and greater than or equal to 0.02 mol % and less than or equal to 1.6 mol % CeO₂.

The articles formed from the glass compositions described herein may be any suitable shape or thickness, which may vary depending on the particular application for use of the glass composition. Glass sheet embodiments may have a thickness greater than or equal to 10 μm, greater than or equal to 15 μm, greater than or equal to 30 μm, greater than or equal to 50 μm, greater than or equal to 100 μm, greater than or equal to 250 μm, greater than or equal to 500 μm, greater than or equal to 750 μm, or even greater than or equal to 1 mm. In embodiments, the glass sheet embodiments may have a thickness less than or equal to 6 mm, less than or equal to 5 mm, less than or equal to 4 mm, less than or equal to 3 mm, less than or equal to 2 mm, or even less than or equal to 1 mm.

In embodiments, the glass sheet embodiments may have a thickness greater than or equal to 30 μm and less than or equal to 6 mm, greater than or equal to 30 μm and less than or equal to 5 mm, greater than or equal to 30 μm and less than or equal to 4 mm, greater than or equal to 30 μm and less than or equal to 3 mm, greater than or equal to 30 μm and less than or equal to 2 mm, greater than or equal to 50 μm and less than or equal to 6 mm, greater than or equal to 50 μm and less than or equal to 5 mm, greater than or equal to 50 μm and less than or equal to 4 mm, greater than or equal to 50 μm and less than or equal to 3 mm, greater than or equal to 50 μm and less than or equal to 2 mm, greater than or equal to 100 μm and less than or equal to 6 mm, greater than or equal to 100 μm and less than or equal to 5 mm, greater than or equal to 100 μm and less than or equal to 4 mm, greater than or equal to 100 μm and less than or equal to 3 mm, greater than or equal to 100 μm and less than or equal to 2 mm, greater than or equal to 250 μm and less than or equal to 6 mm, greater than or equal to 250 μm and less than or equal to 5 mm, greater than or equal to 250 μm and less than or equal to 4 mm, greater than or equal to 250 μm and less than or equal to 3 mm, greater than or equal to 250 μm and less than or equal to 2 mm, greater than or equal to 500 μm and less than or equal to 6 mm, greater than or equal to 500 μm and less than or equal to 5 mm, greater than or equal to 500 μm and less than or equal to 4 mm, greater than or equal to 500 μm and less than or equal to 3 mm, greater than or equal to 500 μm and less than or equal to 2 mm, greater than or equal to 750 μm and less than or equal to 6 mm, greater than or equal to 750 μm and less than or equal to 5 mm, greater than or equal to 750 μm and less than or equal to 4 mm, greater than or equal to 750 μm and less than or equal to 3 mm, greater than or equal to 750 μm and less than or equal to 2 mm, greater than or equal to 1 mm and less than or equal to 6 mm, greater than or equal to 1 mm and less than or equal to 5 mm, greater than or equal to 1 mm and less than or equal to 4 mm, greater than or equal to 1 mm and less than or equal to 3 mm, or even greater than or equal to 1 mm and less than or equal to 2 mm, or any and all sub-ranges formed from any of these endpoints.

In embodiments, the glass composition may have a density greater than or equal to 2.39 g/cm³, greater than or equal to 2.41 g/cm³, or even greater than or equal to 2.45 g/cm³. In embodiments, the glass composition may have a density less than or equal to 2.49 g/cm³, less than or equal to 2.47 g/cm³, or even less than or equal to 2.42 g/cm³. In embodiments, the glass composition may have a density greater than or equal to 2.39 g/cm³ and less than or equal to 2.49 g/cm³, greater than or equal to 2.41 g/cm³ and less than or equal to 2.45 g/cm³, or any and all sub-ranges formed from any of these endpoints.

In embodiments, the glass composition may have a CTE at 500° C. cooling greater than or equal to 3.36 ppm, greater than or equal to 3.5 ppm, or even greater than or equal to 3.6 ppm. In embodiments, the glass composition may have a CTE at 500° C. cooling less than or equal to 3.7 ppm, less than or equal to 3.55 ppm, or even less than or equal to 3.42 ppm. In embodiments, the glass composition may have a CTE at 500° C. cooling greater than or equal to 3.36 ppm and less than or equal to 3.68 ppm, greater than or equal to 3.45 ppm and less than or equal to 3.5 ppm, greater than or equal to 3.4 ppm and less than or equal to 3.6 ppm, or any and all sub-ranges formed from any of these endpoints.

In embodiments, the glass composition may have a CTE at 300° C. cooling greater than or equal to 3.21 ppm, greater than or equal to 3.35 ppm, or even greater than or equal to 3.42 ppm. In embodiments, the glass composition may have a CTE at 300° C. cooling less than or equal to 3.49 ppm, less than or equal to 3.35 ppm, or even less than or equal to 3.25 ppm. In embodiments, the glass composition may have a CTE at 300° C. cooling greater than or equal to 3.21 ppm and less than or equal to 3.49 ppm, greater than or equal to 3.3 ppm and less than or equal to 3.49 ppm, greater than or equal to 3.21 ppm and less than or equal to 3.45 ppm, or any and all sub-ranges formed from any of these endpoints.

In embodiments, the glass composition may have a CTE at 50° C. cooling greater than or equal to 2.79 ppm, greater than or equal to 2.85 ppm, or even greater than or equal to 3 ppm. In embodiments, the glass composition may have a CTE at 50°° C. cooling less than or equal to 3.1 ppm, less than or equal to 2.9 ppm, or even less than or equal to 2.8 ppm. In embodiments, the glass composition may have a CTE at 50° C. cooling greater than or equal to 2.79 ppm and less than or equal to 3.1 ppm, greater than or equal to 3 ppm and less than or equal to 3.1 ppm, greater than or equal to 2.91 ppm and less than or equal to 3.1 ppm, or any and all sub-ranges formed from any of these endpoints.

In embodiments, the glass composition may have a liquidus viscosity greater than or equal to 5 kP, greater than or equal to 50 kP, greater than or equal to 100 kP, or even greater than or equal to 115 kP. In embodiments, the glass composition may have a liquidus viscosity less than or equal to 133 kP, less than or equal to 100 kP, less than or equal to 75 kP, less than or equal to 50 kP, less than or equal to 20 kP, or even less than or equal to 10 kP.

In embodiments, the glass composition may have a liquidus viscosity less than or equal to 780 kP, less than or equal to 700 kP, less than or equal to 600 kP, less than or equal to 500 kP, less than or equal to 400 kP, less than or equal to 300kP, less than or equal to 200 kP, or even less than or equal to 100 kP. In embodiments, the glass composition may have a liquidus viscosity greater than or equal to 31 kP and less than or equal to 780 kP, greater than or equal to 100 kP and less than or equal to 500 kP, greater than or equal to 150 kP and less than or equal to 350 kP, greater than or equal to 31 kP and less than or equal to 250 kP, or any and all sub-ranges formed from any of these endpoints. These ranges of viscosities allow the glass compositions to be formed into sheets by a variety of different techniques including. without limitation, fusion forming, slot draw, floating, rolling, and other sheet-forming processes known to those in the art. However, it should be understood that other processes may be used for forming other articles (i.e., other than sheets).

In embodiments, the glass compositions described herein are ion exchangeable to facilitate strengthening the glass article made from the glass compositions. In typical ion exchange processes, smaller metal ions in the glass compositions are replaced or “exchanged” with larger metal ions of the same valence within a layer that is close to the outer surface of the glass article made from the glass composition. The replacement of smaller ions with larger ions creates a compressive stress within the layer of the glass article made from the glass composition. In embodiments, the metal ions are monovalent metal ions (e.g., Li⁺, Na⁺, K⁺, and the like), and ion exchange is accomplished by immersing the glass article made from the glass composition in a bath comprising at least one molten salt of the larger metal ion that is to replace the smaller metal ion in the glass article. Alternatively, other monovalent ions such as Ag⁺, TI⁺, Cu⁺, and the like may be exchanged for monovalent ions. The ion exchange process or processes that are used to strengthen the glass article made from the glass composition may include, but are not limited to, immersion in a single bath or multiple baths of like or different compositions with washing and/or annealing steps between immersions. In embodiments, the process for making a glass article includes heat treating the glass composition at one or more preselected temperatures for one or more preselected times to induce glass homogenization. In embodiments, the heat treatment for making a glass article may include (i) heating a glass composition at a rate of 1-100 degrees C./min to glass homogenization temperature: (ii) maintaining the glass composition at the glass homogenization temperature for a time greater than or equal to 0.25 hour and less than or equal to 4 hours to produce a glass article: and (iii) cooling the formed glass article to room temperature. In embodiments, the glass homogenization temperature may be greater than or equal to 300° C. and less than or equal to 700° C.

Cooling schedules are judiciously prescribed so as to produce one or more of the following desired attributes: crystalline phase(s) of the glass-ceramic, proportions of one or more major crystalline phases and/or one or more minor crystalline phases and glass, crystal phase assemblages of one or more predominate crystalline phases and/or one or more minor crystalline phases and glass, and grain sizes or grain size distribution among one or more major crystalline phases and/or one or more minor crystalline phases, which in turn may influence the final integrity, quality, color, and/or opacity of the resultant glass-ceramic. In embodiments, the crystalline phase of the glass-ceramic may include, but is not limited to, Aeschynite-Ce, cristobalite, mullite, and/or combinations thereof. The resultant glass may be provided as a sheet, which may then be reformed by pressing, blowing, bending, sagging, vacuum forming, or other means into curved or bent pieces of uniform thickness. Reforming may be done before thermally treating or the forming step may also serve as a thermal treatment step in which both forming and thermal treating are performed substantially simultaneously.

The glass compositions described herein may be used for a variety of applications including, for example, for cover glass or glass backplane applications for UV absorbing applications (e.g. cover plates, UV disinfection components, and/or tanning beds); in consumer or commercial electronic devices including, for example, LCD and LED displays, computer monitors, and automated teller machines (ATMs); for touch screen or touch sensor applications, for portable electronic devices including, for example, mobile telephones, personal media players, and tablet computers; for integrated circuit applications including, for example, semiconductor wafers; for photovoltaic applications; for architectural glass applications; for automotive or vehicular glass applications; or for commercial or household appliance applications. In embodiments, a consumer electronic device (e.g., smartphones, tablet computers, personal computers, ultrabooks, televisions, and cameras), an architectural glass, and/or an automotive glass may comprise a glass article as described herein. An exemplary article incorporating any of the glass compositions disclosed herein may be a consumer electronic device including a housing; electrical components that are at least partially inside or entirely within the housing and including at least a controller, a memory, and a display at or adjacent to the front surface of the housing; and a cover substrate at or over the front surface of the housing such that it is over the display. In some embodiments, at least a portion of at least one of the cover substrates and/or the housing may include any of the glass compositions disclosed herein.

### EXAMPLES

In order that various embodiments be more readily understood, reference is made to the following examples, which are intended to illustrate various embodiments of the glass compositions described herein.

In the tables that follow, a variety of embodied compositions were melted to form the example compositions outlined below, and properties including density, CTE, liquidus temperature, phase, and viscosity were measured from each example composition. Also, for many example compositions, the 50% transmission cutoff in UV is provided by sample thickness, as a measurement of UV absorption capacity.

TABLE I
depicts alkali-containing aluminosilicate glasses having varying amounts of
UV absorbing components, with various Ce + Ti combinations as set out below.

| Example | 1 | 2 | 3 | 4 | 5 | 6 | 7 |
|---|---|---|---|---|---|---|---|
| mol % | | | | | | | |
| SiO2 | 67.60 | 67.50 | 67.40 | 66.70 | 66.60 | 66.50 | 65.70 |
| Al2O3 | 10.25 | 10.25 | 10.25 | 10.25 | 10.25 | 10.25 | 10.25 |
| MgO | 5.40 | 5.40 | 5.40 | 5.40 | 5.40 | 5.40 | 5.40 |
| Na2O | 15.30 | 15.30 | 15.30 | 15.30 | 15.30 | 15.30 | 15.30 |
| TiO2 | 1.00 | 1.00 | 1.00 | 2.00 | 2.00 | 2.00 | 3.00 |
| CeO2 | 0.30 | 0.40 | 0.50 | 0.20 | 0.30 | 0.40 | 0.20 |
| SnO2 | 0.15 | 0.15 | 0.15 | 0.15 | 0.15 | 0.15 | 0.15 |
| sum | 100.00 | 100.00 | 100.00 | 100.00 | 100.00 | 100.00 | 100.00 |
| Properties | | | | | | | |
| Density | 2.468 | 2.473 | 2.469 | 2.475 | 2.481 | 2.476 | 2.486 |
| CTE (0-300 c.) ppm (fiber) | — | — | — | — | — | — | — |
| Liquidus (gradient boat) | | | | | | | |
| duration (hours) | 72 | 72 | 72 | 72 | 72 | 72 | 72 |
| Air (° C.) | 1135 | 1160 | 1085 | 1125 | 1145 | 1075 | 1120 |
| internal (° C.) | 1040 | 1060 | 1075 | 1070 | 1050 | 1075 | 1080 |
| Pt (° C.) | 1040 | 1045 | 1050 | 1055 | 1065 | 1085 | 1075 |
| primary phase | Forsterite | Forsterite | Forsterite | Forsterite | Forsterite | Rutile | Rutile |
| 2ndry phase | — | — | — | — | — | — | — |
| liquidus viscosity (Internal) kP | — | — | — | — | — | — | — |
| Transmission curve | | | | | | | |
| 600 um thick 50% cutoff | 360 | 364 | 358 | 364 | 370 | 352 | 378 |
| 400 um thick 50% cutoff | 354 | 356 | 348 | 356 | 360 | 342 | 366 |
| 200 um thick 50% cutoff | 346 | 348 | 340 | 344 | 348 | 332 | 350 |
| 100 um thick 50% cutoff | — | — | — | — | — | — | — |

TABLE II
depicts alkali-containing boroaluminosilicate glasses having varying amounts of
UV absorbing components, with various Ce + Ti combinations as set out below.

| Example | 8 | 9 | 10 | 11 | 12 |
|---|---|---|---|---|---|
| analyzed mol % | | | | | |
| SiO2 | 66.81 | 67.76 | 67.26 | 67.73 | 67.73 |
| Al2O3 | 12.59 | 12.23 | 12.63 | 12.28 | 12.37 |
| B2O3 (ICP) | 3.51 | 2.67 | 2.70 | 2.25 | 1.71 |
| MgO | 2.20 | 2.26 | 2.25 | 2.29 | 2.28 |
| Na2O | 13.20 | 13.24 | 13.32 | 13.21 | 13.28 |
| TiO2 | 0.00 | 0.96 | 0.96 | 1.45 | 1.93 |
| CeO2 | 1.56 | 0.75 | 0.75 | 0.67 | 0.55 |
| SnO2 | 0.10 | 0.10 | 0.10 | 0.10 | 0.11 |
| Sum | 100.00 | 100.00 | 100.00 | 100.00 | 100.00 |
| Properties | | | | | |
| Density | 2.466 | 2.443 | 2.443 | 2.445 | 2.446 |
| low-T CTE in ppm (from | 7.92 | — | — | — | — |
| CTE bar at 500 C. | | | | | |
| cooling) | | | | | |
| low-T CTE in ppm (from | 7.74 | — | — | — | — |
| CTE bar at 300 C. | | | | | |
| cooling) | | | | | |
| low-T CTE in ppm (from | 7.18 | — | — | — | — |
| CTE bar at 50 C. | | | | | |
| cooling) | | | | | |
| VFT parameters from HTV | | | | | |
| A | −3.291 | −3.232 | −3.806 | −3.901 | −3.681 |
| B | 9034.5 | 8975.4 | 10358.5 | 10748.4 | 10094.7 |
| To | 67.1 | 75.8 | 4.5 | −36.2 | 13.9 |
| ZBD (° C.) | 1220 | 1155 | 1205 | 1210 | 1195 |
| Breakdown Viscosity (kP) | 35.10 | 121.54 | 66.45 | 52.96 | 73.43 |
| Liquidus (gradient boat) | | | | | |
| duration (hours) | 72 | 72 | 72 | 72 | 72 |
| Air (° C.) | 1360 | 1270 | 1220 | 1250 | 1240 |
| internal (C) | 1355 | 1265 | 1240 | 1210 | 1240 |
| Pt (° C.) | 1350 | 1265 | 1240 | 1210 | 1240 |
| primary phase | Aeschynite-Ce | Aeschynite-Ce | Aeschynite-Ce | Aeschynite-Ce | Aeschynite-Ce |
| liquidus viscosity | 5 | 21 | 38 | 53 | 36 |
| (Internal) kP | | | | | |
| Transmission | | | | | |
| 600 um thick 50% cutoff | 414 | — | 426 | 461 | 472 |
| 400 um thick 50% cutoff | 398 | — | 422 | 440 | 451 |
| 200 um thick 50% cutoff | 385 | — | 394 | 416 | 409 |
| 100 um thick 50% cutoff | — | — | — | — | — |

TABLE III
depicts alkaline earth - boroaluminosilicate glasses having varying amounts of
UV absorbing components, with various Ce + Ti combinations as set out below.

| Example | 13 | 14 | 15 | 16 | 17 |
|---|---|---|---|---|---|
| analyzed mol % | | | | | |
| SiO2 | 66.57 | 67.61 | 66.95 | 67.35 | 67.41 |
| Al2O3 | 10.94 | 10.57 | 11.02 | 10.70 | 10.74 |
| B2O3 (ICP) | 9.55 | 8.71 | 8.77 | 8.39 | 7.87 |
| MgO | 2.22 | 2.26 | 2.26 | 2.28 | 2.29 |
| CaO | 8.56 | 8.49 | 8.66 | 8.52 | 8.57 |
| SrO | 0.50 | 0.51 | 0.50 | 0.51 | 0.51 |
| TiO2 | 0.00 | 0.97 | 0.96 | 1.47 | 1.95 |
| CeO2 | 1.57 | 0.77 | 0.77 | 0.67 | 0.57 |
| SnO2 | 0.08 | 0.09 | 0.08 | 0.08 | 0.08 |
| Fe2O3 | 0.00 | 0.01 | 0.01 | 0.01 | 0.01 |
| ZrO2 | 0.01 | 0.01 | 0.01 | 0.01 | 0.01 |
| Sum | 100.00 | 100.00 | 100.00 | 100.00 | 100.00 |
| Properties | | | | | |
| Density | 2.463 | 2.435 | 2.439 | 2.438 | 2.442 |
| low-T CTE in ppm (from | 3.68 | 3.55 | 3.58 | 3.52 | 3.55 |
| CTE bar at 500 C. | | | | | |
| cooling) | | | | | |
| low-T CTE in ppm (from | 3.49 | 3.39 | 3.42 | 3.41 | 3.36 |
| CTE bar at 300 C. | | | | | |
| cooling) | | | | | |
| low-T CTE in ppm (from | 3.10 | 3.04 | 3.06 | 3.09 | 2.94 |
| CTE bar at 50 C. | | | | | |
| cooling) | | | | | |
| VFT parameters from HTV | | | | | |
| A | −2.614 | −2.586 | −2.506 | −2.468 | −2.566 |
| B | 5808.4 | 5917.2 | 5619.5 | 5687.0 | 5819.5 |
| To | 389.3 | 384.0 | 406.6 | 400.0 | 388.1 |
| ZBD (° C.) | >1305 | >1315 | >1375 | >1440 | >1410 |
| Breakdown Viscosity (kP) | <5 | <6 | <2 | <1 | <1.4 |
| Liquidus (gradient boat) | | | | | |
| duration (hours) | 72 | 72 | 72 | 72 | 72 |
| Air (° C.) | 1150 | 1170 | 1155 | 1170 | 1175 |
| internal (° C.) | 1140 | 1160 | 1155 | 1160 | 1170 |
| Pt (° C.) | 1135 | 1150 | 1150 | 1155 | 1165 |
| primary phase | Cristobalite | Cristobalite | Cristobalite | Cristobalite | Cristobalite |
| liquidus viscosity | 133 | 109 | 101 | 103 | 75 |
| (Internal) kP | | | | | |
| Transmission | | | | | |
| 600 um thick 50% cutoff | 350 | — | 350 | 353 | 356 |
| 400 um thick 50% cutoff | 344 | — | 344 | 348 | 348 |
| 200 um thick 50% cutoff | 340 | — | 336 | 339 | 339 |
| 100 um thick 50% cutoff | 338 | — | 334 | 336 | 335 |

TABLE IV
depicts alkaline earth - boroaluminosilicate glasses having varying amounts of UV
absorbing components, with various Ce + Ti + Fe combinations, as set out below.

| Example | 18 | 19 | 20 | 21 | 22 | 23 |
|---|---|---|---|---|---|---|
| analyzed mol % | | | | | | |
| SiO2 | 66.89 | 66.82 | 66.92 | 66.93 | 67.03 | 67.04 |
| Al2O3 | 10.88 | 10.91 | 10.88 | 10.88 | 10.88 | 10.90 |
| B2O3 (ICP) | 10.14 | 10.12 | 10.10 | 10.25 | 10.24 | 10.18 |
| MgO | 0.97 | 1.30 | 1.96 | 0.09 | 0.97 | 1.99 |
| CaO | 8.76 | 8.47 | 7.77 | 8.77 | 7.79 | 6.80 |
| SrO | 0.52 | 0.53 | 0.52 | 0.52 | 0.52 | 0.52 |
| TiO2 | 0.96 | 0.96 | 0.96 | 1.93 | 1.94 | 1.93 |
| CeO2 | 0.77 | 0.77 | 0.77 | 0.51 | 0.51 | 0.52 |
| SnO2 | 0.00 | 0.00 | 0.00 | 0.00 | 0.00 | 0.00 |
| Fe2O3 | 0.09 | 0.09 | 0.09 | 0.09 | 0.09 | 0.09 |
| ZrO2 | 0.01 | 0.01 | 0.01 | 0.01 | 0.01 | 0.01 |
| Sum | 100.00 | 100.00 | 100.00 | 100.00 | 100.00 | 100.00 |
| Properties | | | | | | |
| Density | 2.42 | 2.42 | 2.417 | 2.409 | 2.404 | 2.401 |
| VFT parameters from HTV | | | | | | |
| A | −2.716 | −2.739 | −2.666 | −2.593 | −2.876 | −2.756 |
| B | 6189.2 | 6242.3 | 6117.0 | 6029.9 | 6594.3 | 6299.0 |
| To | 354.4 | 348.1 | 360.5 | 359.8 | 312.5 | 340.7 |
| Liquidus (gradient boat) | | | | | | |
| duration (hours) | 72 | 72 | 72 | 72 | 72 | 72 |
| Air (° C.) | 1115 | 1100 | 1160 | 1170 | 1235 | 1220 |
| internal (° C.) | 1115 | 1095 | 1150 | 1160 | 1200 | 1210 |
| Pt (° C.) | 1100 | 1095 | 1140 | 1150 | 1200 | 1210 |
| primary phase | Mullite | Mullite | Mullite | Mullite | Mullite | Mullite |
| 2ndry phase | Cristobalite | Cristobalite | — | — | — | — |
| liquidus viscosity (Internal) kP | 264 | 416 | 121 | 88 | 36 | 31 |
| Transmission | | | | | | |
| 600 um thick 50% cutoff | 371 | — | — | 374 | — | — |
| 400 um thick 50% cutoff | 363 | — | — | 358 | — | — |
| 200 um thick 50% cutoff | 342 | — | — | 353 | — | — |
| 100 um thick 50% cutoff | 338 | — | — | 346 | — | — |

TABLE V
depicts alkaline earth - boroaluminosilicate glasses having varying amounts of UV
absorbing components, with various Ce + Ti + Fe combinations, as set out below.

| Example | 24 | 25 | 26 | 27 | 28 | 29 |
|---|---|---|---|---|---|---|
| analyzed mol % | | | | | | |
| SiO2 | 67.28 | 67.29 | 67.21 | 67.27 | 67.07 | 67.07 |
| Al2O3 | 9.64 | 9.52 | 9.65 | 9.52 | 9.75 | 9.63 |
| B2O3 (ICP) | 10.11 | 10.13 | 10.11 | 10.06 | 10.21 | 10.22 |
| MgO | 0.62 | 0.49 | 0.61 | 0.49 | 0.74 | 0.62 |
| CaO | 8.89 | 8.87 | 8.91 | 8.90 | 8.89 | 8.87 |
| SrO | 0.53 | 0.53 | 0.53 | 0.53 | 0.53 | 0.53 |
| K20 | 0.01 | 0.01 | 0.01 | 0.01 | 0.01 | 0.01 |
| TiO2 | 1.99 | 1.99 | 2.00 | 2.00 | 1.99 | 1.99 |
| CeO2 | 0.77 | 1.03 | 0.77 | 1.03 | 0.51 | 0.77 |
| SnO2 | 0.00 | 0.00 | 0.00 | 0.00 | 0.00 | 0.00 |
| Fe2O3 | 0.05 | 0.05 | 0.10 | 0.10 | 0.19 | 0.19 |
| ZrO2 | 0.10 | 0.10 | 0.10 | 0.10 | 0.10 | 0.10 |
| Sum | 100.00 | 100.00 | 100.00 | 100.00 | 100.00 | 100.00 |
| Properties | | | | | | |
| Density | 2.42 | 2.43 | 2.422 | 2.433 | 2.415 | 2.425 |
| VFT parameters from HTV | | | | | | |
| A | −2.650 | −2.609 | −2.932 | −2.726 | −2.770 | −2.369 |
| B | 6202.0 | 6125.6 | 6732.0 | 6162.0 | 6391.5 | 5647.3 |
| To | 329.7 | 336.3 | 291.6 | 330.5 | 318.8 | 369.2 |
| Liquidus (gradient boat) | | | | | | |
| duration (hours) | 72 | 72 | 72 | 72 | 72 | 72 |
| Air (° C.) | 1125 | 1120 | 1125 | 1135 | 1115 | 1125 |
| internal (° C.) | 1110 | 1105 | 1105 | 1125 | 1100 | 1115 |
| Pt (° C.) | 1095 | 1095 | 1100 | 1110 | 1085 | 1105 |
| primary phase | Critobalite | Critobalite | Critobalite | Critobalite | Critobalite | Critobalite |
| 2ndry phase | | | | | | |
| liquidus viscosity (Internal) kP | 199 | 229 | 221 | 107 | 258 | 160 |
| Transmission | | | | | | |
| 600 um thick 50% cutoff | — | — | — | — | — | — |
| 400 um thick 50% cutoff | — | — | — | — | — | — |
| 200 um thick 50% cutoff | 354 | 362 | 357 | 360 | 357 | 367 |
| 100 um thick 50% cutoff | — | — | — | — | — | — |

TABLE VI
depicts alkaline earth - boroaluminosilicate glasses having varying amounts of UV
absorbing components, with various Ce + Ti + Fe combinations, as set out below.

| Example | 30 | 31 | 32 | 33 | 34 | 35 |
|---|---|---|---|---|---|---|
| analyzed mol % | | | | | | |
| SiO2 | 67.95 | 67.33 | 67.25 | 68.38 | 68.24 | 68.31 |
| Al2O3 | 9.23 | 9.56 | 9.66 | 9.06 | 9.26 | 9.15 |
| B2O3 | 10.46 | 10.53 | 10.24 | 10.23 | 10.22 | 10.29 |
| MgO | 0.62 | 0.74 | 0.75 | 0.62 | 0.51 | 0.75 |
| CaO | 8.84 | 8.89 | 9.40 | 8.90 | 8.90 | 8.89 |
| SrO | 0.00 | 0.26 | 0.00 | 0.00 | 0.26 | 0.00 |
| TiO2 | 1.98 | 1.98 | 1.99 | 1.99 | 1.99 | 1.98 |
| CeO2 | 0.76 | 0.50 | 0.51 | 0.76 | 0.51 | 0.51 |
| SnO2 | 0.00 | 0.00 | 0.00 | 0.00 | 0.00 | 0.00 |
| Fe2O3 | 0.05 | 0.10 | 0.10 | 0.05 | 0.10 | 0.10 |
| ZrO2 | 0.10 | 0.10 | 0.10 | 0.01 | 0.01 | 0.01 |
| sum | 100.00 | 100.00 | 100.00 | 100.00 | 100.00 | 100.00 |
| Properties | | | | | | |
| Density | 2.399 | 2.400 | 2.402 | 2.396 | 2.394 | 2.386 |
| low-T CTE in ppm (from | 3.39 | 3.45 | 3.47 | 3.39 | 3.40 | 3.37 |
| CTE bar at 500 C. cooling) | | | | | | |
| low-T CTE in ppm (from | 3.29 | 3.32 | 3.34 | 3.29 | 3.29 | 3.26 |
| CTE bar at 300 C. cooling) | | | | | | |
| low-T CTE in ppm (from | 3.03 | 2.99 | 3.03 | 3.02 | 2.99 | 2.95 |
| CTE bar at 50 C. cooling) | | | | | | |
| VFT parameters from HTV | | | | | | |
| A | −2.633 | −2.677 | −2.772 | −2.701 | −2.804 | −2.659 |
| B | 6294.6 | 6206.1 | 6441.7 | 6436.7 | 6718.6 | 6422.6 |
| To | 326.4 | 332.6 | 315.4 | 321.6 | 293.0 | 319.6 |
| Liquidus (gradient boat) | | | | | | |
| duration (hours) | 72 | 72 | 72 | 72 | 72 | 72 |
| Air (° C.) | 1135 | 1120 | 1125 | 1130 | 1130 | 1130 |
| internal (° C.) | 1120 | 1105 | 1110 | 1115 | 1120 | 1120 |
| Pt (° C.) | 1105 | 1100 | 1100 | 1105 | 1110 | 1105 |
| primary phase | Cristobalite | Cristobalite | Cristobalite | Cristobalite | Cristobalite | Cristobalite |
| 2ndry phase | | | | | | |
| liquidus viscosity (Internal) | 199 | 228 | 216 | 258 | 209 | 232 |
| kP | | | | | | |

TABLE VII
depicts alkaline earth - boroaluminosilicate glasses having varying amounts of UV
absorbing components, with various Ce + Ti + Fe combinations, as set out below.

| Example | 36 | 37 | 38 | 39 | 40 | 41 |
|---|---|---|---|---|---|---|
| analyzed mol % | | | | | | |
| SiO2 | 67.55 | 67.75 | 67.82 | 67.87 | 67.84 | 67.90 |
| Al2O3 | 10.67 | 10.29 | 9.88 | 9.48 | 9.08 | 9.10 |
| B2O3 (ICP) | 10.06 | 10.07 | 10.27 | 10.49 | 10.79 | 10.62 |
| MgO | 1.91 | 1.55 | 1.19 | 0.83 | 0.47 | 0.47 |
| CaO | 8.74 | 8.78 | 8.80 | 8.83 | 8.85 | 8.92 |
| SrO | 0.44 | 0.37 | 0.31 | 0.24 | 0.16 | 0.17 |
| TiO2 | 0.40 | 0.79 | 1.19 | 1.59 | 1.99 | 2.00 |
| CeO2 | 0.15 | 0.31 | 0.46 | 0.61 | 0.76 | 0.77 |
| SnO2 | 0.06 | 0.05 | 0.03 | 0.02 | 0.00 | 0.00 |
| Fe2O3 | 0.01 | 0.02 | 0.03 | 0.04 | 0.05 | 0.05 |
| ZrO2 | 0.01 | 0.01 | 0.01 | 0.01 | 0.01 | 0.01 |
| Sum | 100.00 | 100.00 | 100.00 | 100.00 | 100.00 | 100.00 |
| Properties | | | | | | |
| Density | 2.39 | 2.392 | 2.393 | 2.395 | 2.397 | 2.401 |
| CTE (0-300 c.) ppm (fiber) | — | — | — | — | — | 32.2 |
| Stain Point (fiber Elongation) | — | — | — | — | — | 653.0 |
| Annealing Point (fiber Elongation) | — | — | — | — | — | 704.0 |
| Softening Point (fiber Elongation) | — | — | — | — | — | 956.0 |
| low-T CTE in ppm | | | | | | |
| (from CTE bar at 500 C. cooling) | 3.38 | 3.40 | 3.37 | 3.40 | 3.36 | 3.39 |
| low-T CTE in ppm | 3.21 | 3.25 | 3.21 | 3.26 | 3.25 | 3.28 |
| (from CTE bar at 300 C. cooling) | | | | | | |
| low-T CTE in ppm | 2.79 | 2.90 | 2.88 | 2.94 | 3.00 | 2.94 |
| (from CTE bar at 50 C. cooling) | | | | | | |
| High-T CTE in ppm | | | | | | 15.39 |
| Strain PT (BBV) (10\hat{ }14.68 P) | — | — | — | — | — | 666.4 |
| Annealing PT (BBV) (10\hat{ }13.18 P) | — | — | — | — | — | 717.1 |
| Soft PT (PPV) (10\hat{ }7.6 P) | — | — | — | — | — | 949.7 |
| Young's modulus (GPa) | — | — | — | — | — | 71.7 |
| Shear's modulus (GPa) | — | — | — | — | — | 29.2 |
| Poisson's ratio | — | — | — | — | — | 0.226 |
| VFT parameters from HTV | | | | | | |
| A | −2.632 | −2.706 | −2.538 | −2.831 | −2.349 | −2.799 |
| B | 6181.5 | 6368.5 | 5794.8 | 6500.5 | 5733.1 | 6627.5 |
| To | 354.7 | 336.4 | 392.6 | 326.0 | 369.3 | 310.5 |
| Liquidus (gradient boat) | | | | | | |
| duration (hours) | 72 | 72 | 72 | 72 | 72 | 72 |
| Air (° C.) | 1080 | 1120 | 1105 | 1030 | 1110 | 1110 |
| internal (° C.) | 1080 | 1100 | 1100 | 1025 | 1110 | 1100 |
| Pt (° C.) | 1080 | 1110 | 1080 | 1015 | 1090 | 1090 |
| primary phase | Cristobalite | Cristobalite | Cristobalite | Cristobalite | Cristobalite | Cristobalite |
| 2ndry phase | | | | | | |
| liquidus viscosity (Internal) kP | 777 | 431 | 450 | — | 246 | 394 |
| 1000 um thick 50% cutoff | 334 | 346 | 360 | 376 | 394 | 396 |
| 500 um thick 50% cutoff | 326 | 336 | 348 | 362 | 376 | 378 |
| 250 um thick 50% cutoff | 320 | 330 | 338 | 348 | 360 | 358 |

TABLE IX
Composition ranges for the UV absorbing components

| Component | Max mol % | Min mol % |
|---|---|---|
| TiO₂ | 3.00 | 0.00 |
| CeO₂ | 1.57 | 0.20 |
| Fe₂O₃ | 0.19 | 0.00 |

TABLE X
Composition ranges for all compositions disclosed herein.

| Measured | | |
|---|---|---|
| Composition | Max mol % | Min mol % |
| SiO₂ | 68.00 | 65.70 |
| Al₂O₃ | 12.63 | 9.00 |
| B₂O₃ (ICP) | 11.20 | 1.71 |
| MgO | 5.40 | 0.09 |
| CaO | 9.39 | 0.02 |
| SrO | 0.53 | 0.00 |
| Na₂O | 15.30 | 0.00 |
| K₂O | 0.01 | 0.00 |
| TiO₂ | 3.00 | 0.00 |
| CeO₂ | 1.57 | 0.20 |
| SnO₂ | 0.15 | 0.00 |
| Fe₂O₃ | 0.19 | 0.00 |
| ZrO₂ | 0.10 | 0.00 |

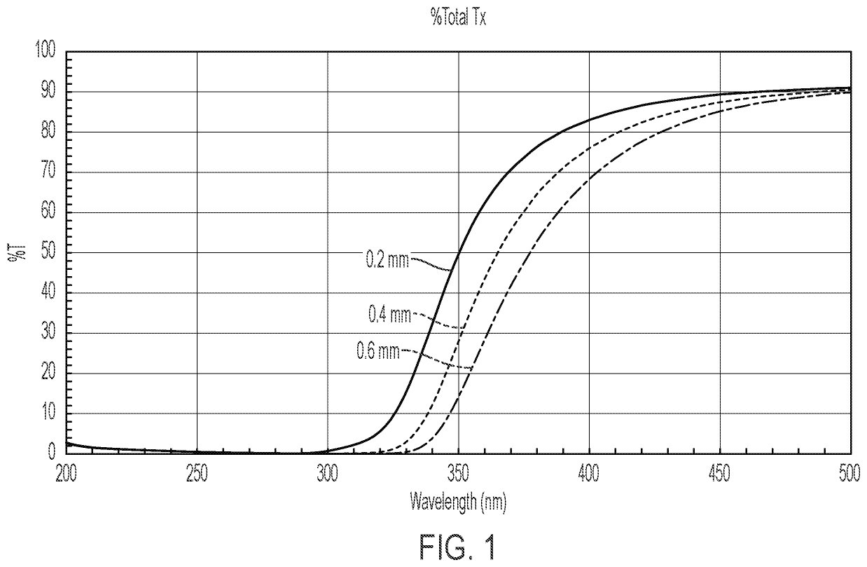

FIG. 1 provides transmission curves of Example 7 compositions at substrates having three different thicknesses, depicting an example of the effect that thickness and UV absorbing components, including cerium content and titanium content, have on the resulting UV transmission of some embodiments of the present disclosure. These UV absorbing components provide similar behaviors in the additional embodiments disclosed herein, according to one or more aspects of the present disclosure.

FIG. 1 provides a graph of percent total transmission for Example 7 composition, an embodiment of the present disclosure, depicting the impact of substrate thickness on transmission. Three different thicknesses are plotted, 0.2 mm: 0.4 mm; and 0.6 mm, where the left-most transmission curve corresponds to the 0.2 mm thick Example 7 composition, the center transmission curve corresponds to the 0.4 mm Example 7 composition: and the right-most transmission curve corresponds to the 0.6 mm Example 7 composition. The general trend shown is that by increasing thickness for a UV-absorbing composition, the resulting transmission decreases for a particular UV wavelength. Here, this is depicted by arrow denoting the 350 nm wavelength, where transmission for 0.2 mm is roughly 50%; transmission for 0.4 mm is roughly 27%; and transmission for 0.6 mm is approximately 15%.

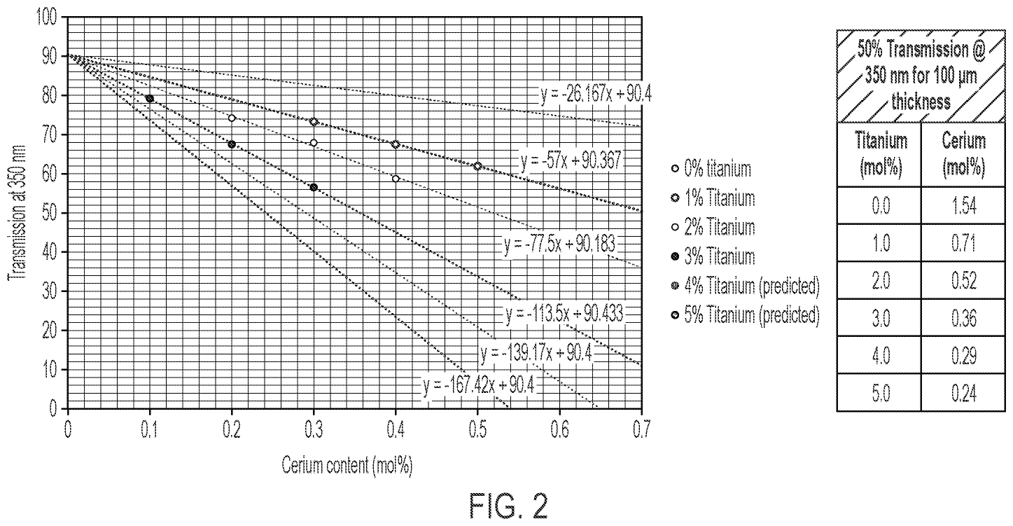

FIG. 2 provides a series of modeled percent transmission at 350 nm for varying UV absorbing component amounts, as specified in the accompanying table. The data points on the graph depict measured values, while the trend lines (dotted lines and/or accompanying equations) provide extrapolated percent transmission for varying compounds, in accordance with one or more aspects of the present disclosure.

The chart that accompanies the plot, in FIG. 2, depicts varying two types of UV absorbing components, Titanium and Cerium. Titanium ranges from 0.0 mol. % to 5 mol. %, with cerium ranging from 1.54 mol %, down to 0.24 mol. %, For the samples plotted in FIG. 2, as Titanium amount increases, Cerium amount decreases, with a higher overall Titanium content than cerium content (i.e. for all cases except for when cerium is the only UV absorbing component in the composition and Ti is at 0.0 Mol. %). For a given glass composition embodiment, there is a certain amount of Ce, or Ce+Ti that is required to achieve a given transmission target (e.g. at least 50%) at 350 nm. Also, it's noted, when using only cerium as the UV absorbing component, a lot more cerium is required to achieve the same transmission target as compared to the additive or synergistic effect of adding titanium and cerium together. In this instance, it's noted that with titanium, the amount of cerium is reduced by approximately 50% at 1 mol % titanium, or by 66% at 2 mol % titanium to achieve the same transmission properties/UV absorption at target wavelength. Samples for this example were 100 microns thick, with the target at 50% transmission at a target wavelength of 350 nm.

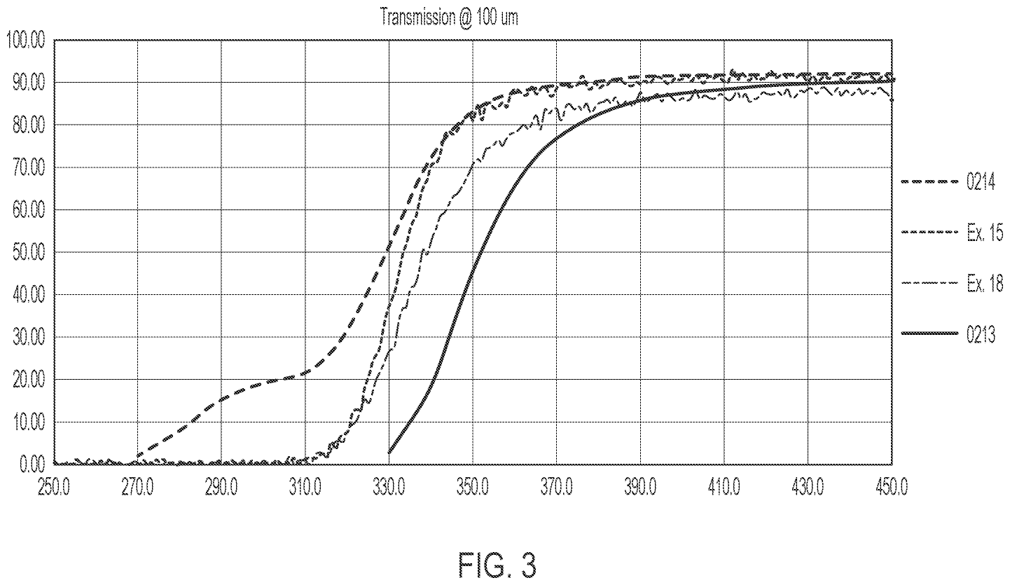

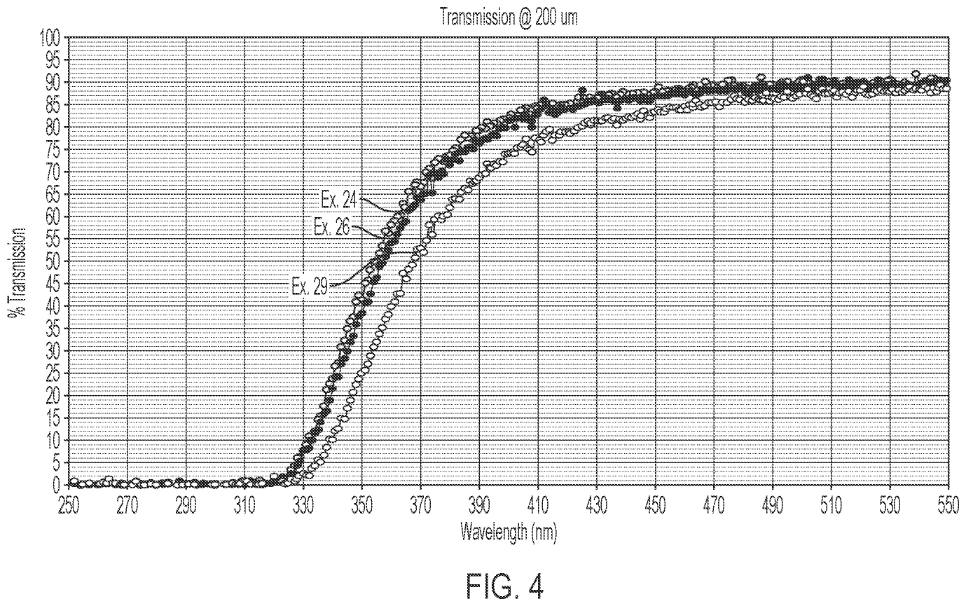

FIG. 3 depicts a graph of transmission curves for four different compositions, two of embodiments of the present invention (example 15 and example 18), and for reference purposes, two comparative compositions with UV absorbing capabilities, but at a very different composition (0213 and 0214, commercially available through Corning Incorporated). The transmission curves for all four samples are for 100 micron thick substrates, shown as % transmission by wavelength (and showing mostly UV spectrum). As shown in the figure, both embodiment compositions example 15 and 18 have transmission curves at the UV depicting absorption curves consistent with and between reference compositions 0213 and 0214 at the target wavelength range, i.e. between above 270 to 400 nm. Referring to FIGS. 3 and 4, with certain embodiments of the present disclosure, used individually, or in combination with one or more UV absorbing components described herein, is utilized to adjust the UV absorbing attribute of various glass compositions, in accordance with the present disclosure. As depicted in FIG. 3, Example 15 is iron-free, while Example 18 is a slightly modified composition from Example 15 to accommodate a 0.1 mol. % UV absorbing component addition, here, iron. With a small amount of iron addition, the transmission curve shifts, as depicted by black arrow in FIG. 3.

FIG. 4 depicts a series of transmission curves plotted for embodiment compositions of the present disclosure, Example 24, Example 26, and Example 29 (also coinciding with left-most transmission curve to right-most transmission curve as depicted in FIG. 4). Referring to FIG. 4, the further increased addition of iron in various amounts to a glass containing 2.0 mol % TiO₂+0.75 mol % CeO₂ results in a sensitivity to UV absorption, as evidenced by the shift in transmission curves for Example 24 vs Example 26 vs. Example 29. In similar fashion to FIG. 3 Examples 15 and 18, in FIG. 4, the trend depicted is that further addition of UV absorbing component iron in various amounts (here, in combination with UV absorbing component Ti), the transmission curve shifts with additional iron.

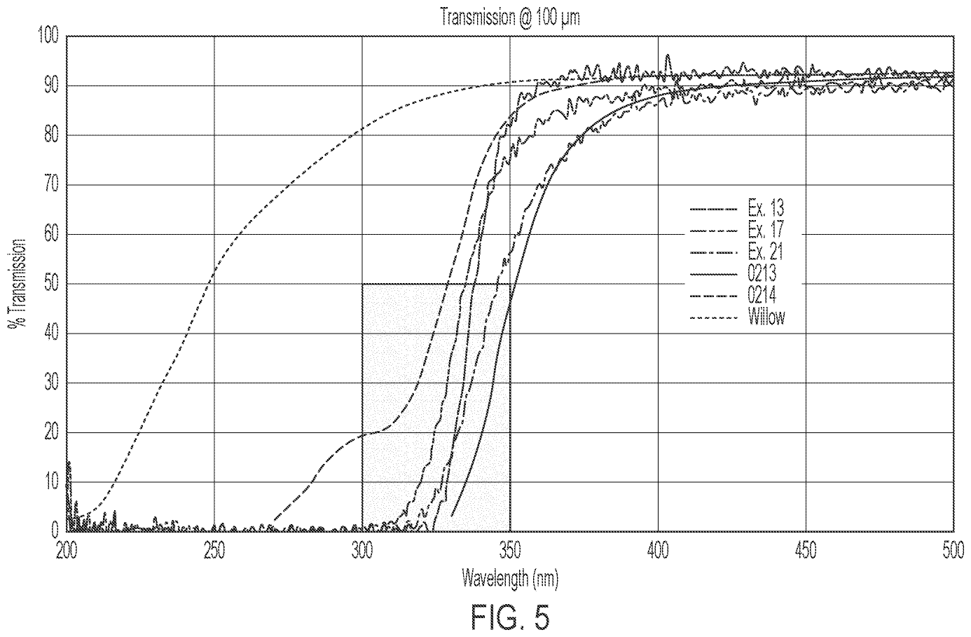

FIG. 5 depicts transmission curves for three embodiments of the present disclosure (Example 13, Example 17, and Example 21) as compared to three comparative examples, including Willow® glass, 0213, and 0214, each of which is commercially available from Corning Incorporated. All substrates were evaluated for substrates having a thickness of 100 microns. As shown in FIG. 5, Willow® has a lower capacity for UV absorption as compared to 0213 and 0214 and all of the present embodiment example compositions depicted. Moreover, the three embodiments, Example 13, 17, and 21, have transmission curves that lie roughly between 0213 and 0214 between the UV wavelength range in the targeted transmission area (i.e. denoted by the shaded box, less than 50% transmission between 300 nm-3350 nm, in FIG. 5). FIG. 5 illustrates some of the compositions having targeted UV absorption at particular wavelengths, when configured in thin cross-sections (e.g. 100 microns) in accordance with one or more aspects of the present disclosure.

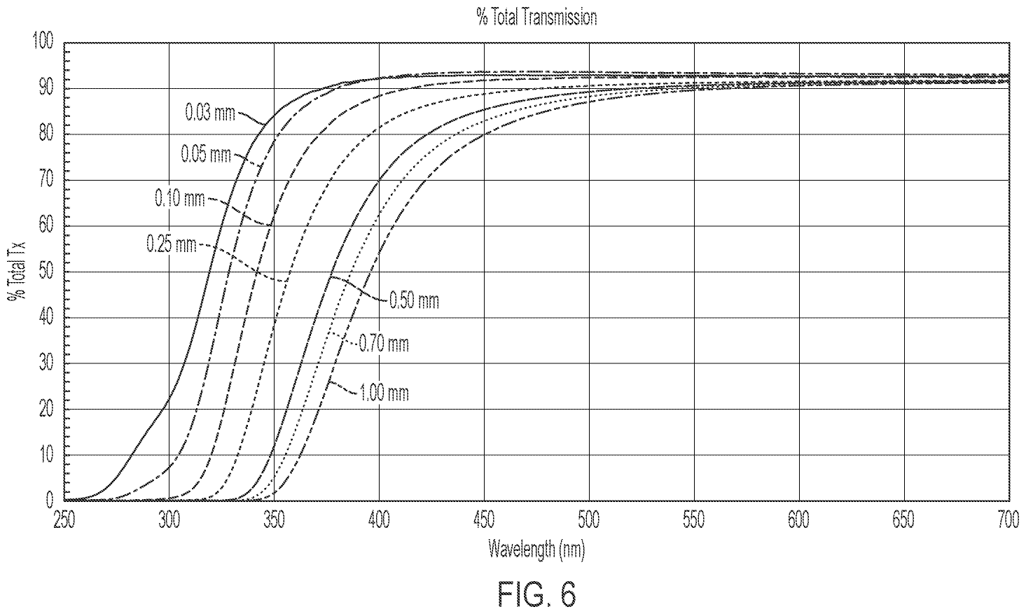

FIG. 6 depicts seven percent total transmission curves, plotted as % total transmission by wavelength in nm, for embodiment of Example 41 at four different sample thicknesses, in accordance with one or more aspects of the present disclosure. As thickness increases (from 0.03 to 0.05 to 0.10 to 0.25 mm thick to 0.50 mm thick to 0.70 mm thick to 1.00 mm thick), the wavelength of 50% transmission shifts upward (from approximately 320nm to 330nm to 340nm to 360nm to 375nm to 380 nm to 395nm).

It will be apparent to those skilled in the art that various modifications and variations may be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. A glass composition comprising:
greater than or equal to 65.7 mol % and less than or equal to 68 mol % SiO₂;
greater than or equal to 9 mol % and less than or equal to 12.6 mol % Al₂O₃;
greater than or equal to 1.7 mol % and less than or equal to 11.2 mol % B₂O₃;
greater than or equal to 0.09 mol % and less than or equal to 5.4 mol % MgO;
greater than or equal to 0.02 mol % and less than or equal to 9.39 mol % CaO, and
greater than or equal to 0.02 mol % and less than or equal to 1.6 mol % CeO₂.

2. The glass composition of claim 1, further comprising:
less than or equal to 3 mol % TiO₂, where at least some TiO₂ is present.

3. The glass composition of claim 1, further comprising:
greater than or equal to 0.4 mol % and less than or equal to 2.5 mol % TiO₂.

4. The glass composition of claim 1, further comprising:
greater than or equal to 1 mol % and less than or equal to 3 mol % TiO₂.

5. The glass composition of claim 1, further comprising:
less than or equal to 0.2 mol % Fe₂O₃, where at least some Fe₂O₃ is present.

6. The glass composition of claim 1, further comprising:
greater than or equal to 0.01 mol % and less than or equal to 0.1 mol % Fe₂O₃.

7. The glass composition of claim 1, further comprising:
greater than or equal to 0.1 mol % and less than or equal to 0.8 mol % CeO₂.

8. The glass composition of claim 1, wherein the glass composition comprises greater than or equal to 0.4 mol % and less than or equal to 2 mol % MgO.

9. The glass composition of claim 1, wherein the glass composition comprises greater than or equal to 6 mol % and less than or equal to 9 mol % CaO.

10. The glass composition of claim 1, wherein the glass composition comprises greater than or equal to 5 mol % and less than or equal to 11.2 mol % B₂O₃.

11. The glass composition of claim 1, wherein the glass composition comprises greater than or equal to 0.15 mol % and less than or equal to 0.5 mol % SrO.

12. The glass composition of claim 1, wherein the glass composition comprises less than or equal to 15.3 mol % Na₂O, where at least some Na₂O is present.

13. The glass composition of claim 1, wherein the glass composition comprises less than or equal to 0.01 mol % K₂O, where at least some K₂O is present.

14. The glass composition of claim 1, wherein the glass composition comprises less than or equal to 0.15 mol % SnO₂, where at least some SnO₂ is present.

15. The glass composition of claim 1, wherein the glass composition comprises less than or equal to 0.1 mol % ZrO₂, where at least some ZrO₂ is present.

16. The glass composition of claim 1, wherein the glass composition has density of not greater than 2.4.

17. The glass composition of claim 1, wherein the glass composition has CTE when measured at 500 degrees C., of not greater than 3.4 ppm.

18. The glass composition of claim 1, wherein the glass composition, having a thickness of 250 microns, has a 50% transmission percentage at a UV wavelength in the range of 320 to 350 nm.

19. A glass composition comprising:
greater than or equal to 66 mol % and less than or equal to 68 mol % SiO₂;
greater than or equal to 9 mol % and less than or equal to 11 mol % Al₂O₃;
greater than or equal to 10 mol % and less than or equal to 11.2 mol % B₂O₃;
greater than or equal to 0.4 mol % and less than or equal to 2 mol % MgO;
greater than or equal to 6 mol % and less than or equal to 9.4 mol % CaO;
greater than or equal to 0.15 mol % and less than or equal to 0.5 mol % SrO;
greater than or equal to 0.4 mol % and less than or equal to 2 mol % TiO₂;
greater than or equal to 0.1 mol % and less than or equal to 1 mol % CeO₂;
greater than or equal to 0.01 mol % and less than or equal to 0.05 mol % Fe₂O₃; and
not greater than or equal to 0.01 mol %, where at least some ZrO₂ is present.

20. The composition of claim 19, wherein the glass composition further comprises:
not greater than or equal to 0.06 mol % SnO₂, where at least some SnO₂ is present.

21. A glass composition comprising:
greater than or equal to 66 mol % and less than or equal to 68 mol % SiO₂;
greater than or equal to 9 mol % and less than or equal to 11 mol % Al₂O₃;
greater than or equal to 10 mol % and less than or equal to 11.2 mol % B₂O₃;
greater than or equal to 0.4 mol % and less than or equal to 2 mol % MgO;
greater than or equal to 6 mol % and less than or equal to 9.4 mol % CaO;
greater than or equal to 0.4 mol % and less than or equal to 2 mol % TiO₂;
greater than or equal to 0.4 mol % and less than or equal to 0.8 mol % CeO₂;
greater than or equal to 0.05 mol % and less than or equal to 0.1 mol % Fe₂O₃; and
greater than or equal to 0.01 mol % and less than or equal to 0.1 mol % ZrO₂.

22. The composition of claim 21, wherein the glass composition further comprises:
not greater than or equal to 0.26 mol % SrO, where at least some SrO is present.

23. A glass composition comprising:
greater than or equal to 66 mol % and less than or equal to 68 mol % SiO₂;
greater than or equal to 9 mol % and less than or equal to 11 mol % Al₂O₃;
greater than or equal to 10 mol % and less than or equal to 11.2 mol % B₂O₃;
greater than or equal to 0.4 mol % and less than or equal to 0.8 mol % MgO;
greater than or equal to 7 mol % and less than or equal to 9.4 mol % CaO;
greater than or equal to 0.4 mol % and less than or equal to 0.7 mol % SrO;
not greater than or equal to 0.01 mol % K₂O, where at least some K₂O is present;
greater than or equal to 0.5 mol % and less than or equal to 2.5 mol % TiO₂;
greater than or equal to 0.4 mol % and less than or equal to 1.5 mol % CeO₂;
greater than or equal to 0.05 mol % and less than or equal to 0.2 mol % Fe₂O₃; and
not greater than or equal to 0.01 mol %, where at least some ZrO₂ is present.

24. A glass composition comprising:
greater than or equal to 66 mol % and less than or equal to 68 mol % SiO₂;
greater than or equal to 9 mol % and less than or equal to 11 mol % Al₂O₃;
greater than or equal to 10 mol % and less than or equal to 11.2 mol % B₂O₃;
greater than or equal to 0.09 mol % and less than or equal to 2 mol % MgO;
greater than or equal to 7 mol % and less than or equal to 9.4 mol % CaO;
greater than or equal to 0.4 mol % and less than or equal to 0.7 mol % SrO;
greater than or equal to 0.8 mol % and less than or equal to 2.5 mol % TiO₂;
greater than or equal to 0.4 mol % and less than or equal to 1 mol % CeO₂;
not greater than 0.09 mol % Fe₂O₃, wherein at least some Fe₂O₃ is present; and
greater than or equal to 0.01 mol % ZrO₂, where at least some ZrO₂ is present.

25. A glass composition comprising:
greater than or equal to 66 mol % and less than or equal to 68 mol % SiO₂;
greater than or equal to 9 mol % and less than or equal to 11 mol % Al₂O₃;
greater than or equal to 7 mol % and less than or equal to 11.2 mol % B₂O₃;
greater than or equal to 1.5 mol % and less than or equal to 2.5 mol % MgO;
greater than or equal to 7 mol % and less than or equal to 9.4 mol % CaO;
greater than or equal to 0.4 mol % and less than or equal to 0.7 mol % SrO;
greater than or equal to 0.4 mol % and less than or equal to 1.6 mol % CeO₂;
greater than or equal to 0.07 mol % and less than or equal to 0.1 mol % SnO₂; and
greater than or equal to 0.01 mol % ZrO₂, where at least some ZrO₂ is present.

26. The composition of claim 25, wherein the glass composition further comprises:
greater than or equal to 0.8 mol % and less than or equal to 2.5 mol % TiO₂.

27. The composition of claim 25, wherein the glass composition further comprises:
not greater than 0.01 mol % Fe₂O₃, wherein at least some Fe₂O₃ is present.

28. A glass composition comprising:
greater than or equal to 66 mol % and less than or equal to 68 mol % SiO₂;
greater than or equal to 11 mol % and less than or equal to 13 mol % Al₂O₃;
greater than or equal to 1.7 mol % and less than or equal to 4 mol % B₂O₃;
greater than or equal to 1.5 mol % and less than or equal to 2.5 mol % MgO;
greater than or equal to 11 mol % and less than or equal to 14 mol % Na₂O;
greater than or equal to 0.4 mol % and less than or equal to 1.6 mol % CeO₂; and
greater than or equal to 0.07 mol % and less than or equal to 0.15 mol % SnO₂.

29. The composition of claim 28, wherein the glass composition further comprises:
greater than or equal to 0.8 mol % and less than or equal to 2.5 mol % TiO₂.

30. A glass composition comprising:
greater than or equal to 66 mol % and less than or equal to 68 mol % SiO₂;
greater than or equal to 11 mol % and less than or equal to 13 mol % Al₂O₃;
greater than or equal to 4 mol % and less than or equal to 6.5 mol % MgO;
greater than or equal to 11 mol % and less than or equal to 15.3 mol % Na₂O;
greater than or equal to 0.8 mol % and less than or equal to 3 mol % TiO₂.
greater than or equal to 0.2 mol % and less than or equal to 0.6 mol % CeO₂; and
greater than or equal to 0.07 mol % and less than or equal to 0.15 mol % SnO₂.
